(19) United States
(12) Patent Application Publication
(10) Pub. No.: US 2026/0112072 A1
(43) Pub. Date: Apr. 23, 2026

(54) CONDITIONED IMAGE GENERATION

(71) Applicant: Shutterstock, Inc., New York, NY (US)

(72) Inventors: Raúl Gómez Bruballa, Dublin (IE); Alessandra Sala, Dublin (IE)

(21) Appl. No.: 18/919,866

(22) Filed: Oct. 18, 2024

(51) Int. Cl. G06T 11/00; G06V 10/70; G06V 10/774; G06V 10/82

(52) U.S. Cl. CPC G06T 11/00; G06V 10/768; G06V 10/774; G06V 10/82

(57) ABSTRACT

A method for image generation includes receiving a training data that includes training images, image captions each corresponding to one of the training images, and contextual features each associated with one or more of the training images. The method further includes performing a training process to condition a generative image model using the training images, the image captions, and the contextual features, resulting in a conditioned model that generates images conditioned to both the image captions and the contextual features.

### TECHNICAL FIELD

The present disclosure generally relates to image generation, and particularly to training of image generative models.

### BACKGROUND

Text-to-image models generate images conditioned to an input text. To learn to do that they are trained to, given a text associated with a training image, reconstruct it. During inference, a user can prompt them with any text, and they generate an image aligned with it. However, the model has no knowledge of the user’s context beyond what is provided in the prompt.

As such, there is a need for image generation conditioned to the user’s context.

### SUMMARY

Some embodiments of the present disclosure provide a method for image generation. The method includes receiving a training data that includes training images, image captions each corresponding to one of the training images, and contextual features each associated with one or more of the training images. The method further includes performing a training process to condition a generative image model using the training images, the image captions, and the contextual features, resulting in a conditioned model that generates images conditioned to both the image captions and the contextual features.

Some embodiments of the present disclosure provide a non-transitory computer-readable medium storing a program for image generation. The program, when executed by a computer, configures the computer to receive a training data that includes training images, image captions each corresponding to one of the training images, and contextual features each associated with one or more of the training images. The program, when executed by a computer, further configures the computer to perform a training process to condition a generative image model using the training images, the image captions, and the contextual features, resulting in a conditioned model that generates images conditioned to both the image captions and the contextual features.

Some embodiments of the present disclosure provide a system for image generation. The system comprises a processor and a non-transitory computer readable medium storing a set of instructions, which when executed by the processor, configure the processor to receive a training data that includes training images, image captions each corresponding to one of the training images, and contextual features each associated with one or more of the training images. The instructions, when executed by the processor, further configure the processor to perform a training process to condition a generative image model using the training images, the image captions, and the contextual features, resulting in a conditioned model that generates images conditioned to both the image captions and the contextual features.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement image generation, according to some embodiments.

FIG. 2 is a block diagram illustrating details of a system for image generation, according to some embodiments.

FIG. 3A is a flowchart illustrating a process for conditioned image generation, according to some embodiments.

FIG. 3B is a flowchart illustrating a process for image generation model selection, according to some embodiments.

FIG. 4 is a block diagram that illustrates training and inference using multiple image generation models, according to some embodiments.

FIG. 5 is a block diagram that illustrates micro-conditioning an image generation model to multiple contextual features, according to some embodiments.

FIG. 6 is a block diagram that illustrates training multiple image generation models, each of them micro-conditioned to different contextual features, according to some embodiments.

FIG. 7A and FIG. 7B show a block diagram that illustrates inference scenarios where a single image generation model is conditioned to different context features, according to some embodiments.

FIG. 8A and FIG. 8B show a block diagram that illustrates inference scenarios where model selection is performed based on context features, where the selected image generation models are conditioned to different context features, according to some embodiments.

FIG. 9 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “generative image models” as used herein refers, in some embodiments, to artificial intelligence-based (AI) and/or machine learning (ML) models designed to generate high-quality images based on text or image inputs. These models employ various techniques including, but not limited to, diffusion models, latent diffusion models, generative adversarial networks (GANs), variational autoencoders (VAEs), autoregressive models, and transformer-based architectures. The terms “image generator” and “image generation model” are used equivalently herein to refer to generative image models.

The term “loss function” as used herein refers, according to some embodiments, to mathematical functions that are used in the training of generative image models. These functions quantify the discrepancy between the model’s predictions and the ground truth (i.e., the training data) to guide an iterative optimization process, enabling the trained model to generate accurate and diverse output images. Examples of loss functions for generative image models include, but are not limited to, mean squared error (MSE), cross-entropy, Wasserstein distance, and Kullback-Leibler (KL) divergence. The term “reconstruction loss” may be used herein to refer to the discrepancy between the model’s predictions and the ground truth during a single iteration of the training process.

The term “optimization loss” as used herein refers, according to some embodiments, to an overall objective of minimizing the discrepancy being measured by the loss function to improve the model's performance. In other words, the loss function evaluates individual predictions and guiding model adjustments, and the optimization loss seeks to minimize error across the entire training dataset, by iteratively adjusting model parameters during training.

Text-to-image models may be conditioned to different information instead of or combined with text. Examples of conditioning text-to-image models to additional information (equivalently referred to herein as “micro-conditioning”) is provided in U.S. Patent No. 12,106,548 (“Balanced Generative Image Model Training”) issued on October 1, 2024, and incorporated herein by reference, and also provided in pending U.S. Application No. 18/638,017 (“Moderated Generative Image Model Training”) filed on April 17, 2024, and incorporated herein by reference.

Recommender systems are models that are trained to learn synergies between two feature sets, typically users and content (i.e., images). Users' features sets can be very diverse, including but not limited to a user ID, a user profile, a location, session information (i.e., latest user searches), user-selected search filters, or any other information. Recommender systems may be trained to score users and assets (i.e., images) and leveraged to provide personalized recommendations to users.

Embodiments of the present disclosure address the above identified needs using micro-conditioning to personalize image generation using the user’s context. Some embodiments combine generative models (to generate new content) and recommender systems (to personalize content). Some embodiments extend the idea of micro-conditioning to diverse conditioning features based on the inference and user-provided context and focus on an inference scenario where generations are personalized.

To provide personalized generations, some embodiments use one or both of model selection based on context features, and model micro-conditioning to context features. Generative orchestrations that combine model selection and micro-conditioning may be used to provide personalized generated content in some embodiments.

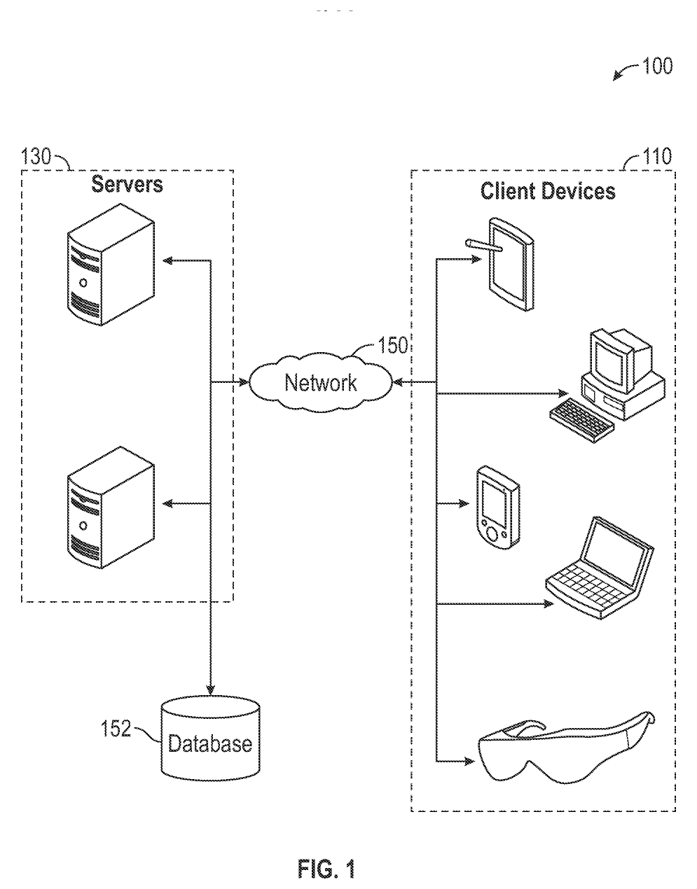

FIG. 1 illustrates a network architecture 100 used to implement image generation, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

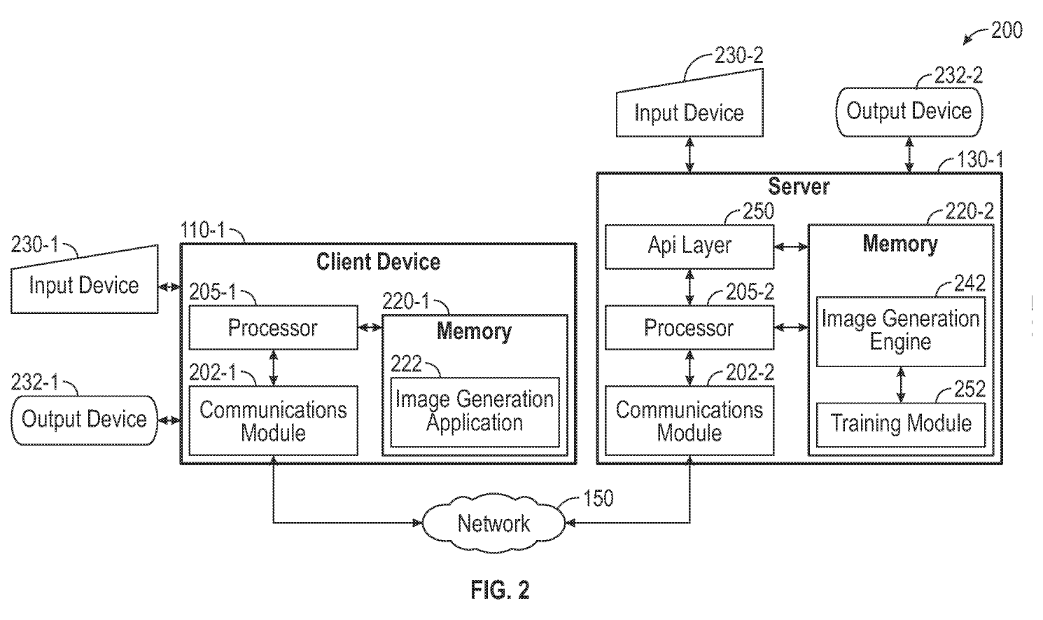

FIG. 2 is a block diagram illustrating details of a system 200 for image generation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an image generation application 222, configured to execute on client device 110-1 and couple with input device 230-1 and output device 232-1. The image generation application 222 may be downloaded by the user from server 130-1, and/or may be hosted by server 130-1. The image generation application 222 may include specific instructions which, when executed by processor 205-1, cause operations to be performed consistent with embodiments of the present disclosure. In some embodiments, the image generation application 222 runs on an operating system (OS) installed in client device 110-1. In some embodiments, image generation application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an image generation engine 242. The image generation engine 242 may include one or more image generation models that may be configured to perform methods and operations consistent with embodiments of the present disclosure. The image generation engine 242 may share or provide features and resources with the client device 110-1, including data, libraries, and/or applications retrieved with image generation engine 242 (e.g., image generation application 222). The user may access the image generation engine 242 through the image generation application 222. The image generation application 222 may be installed in client device 110-1 by the image generation engine 242 and/or may execute scripts, routines, programs, applications, generative image models, and the like provided by the image generation engine 242. In some embodiments, image generation application 222 may communicate with image generation engine 242 through an API layer 250.

In some embodiments, memory 220-2 includes training module 252. The training module 252 may be configured to perform methods and operations consistent with embodiments of the present disclosure. For example, training module 252 may perform a training process on one or more image generation models executed by the image generation engine 242. The training module 252 may use training data either stored in memory 220-2 or retrieved from an external database (e.g., database 152) to perform the training process on the image generation models.

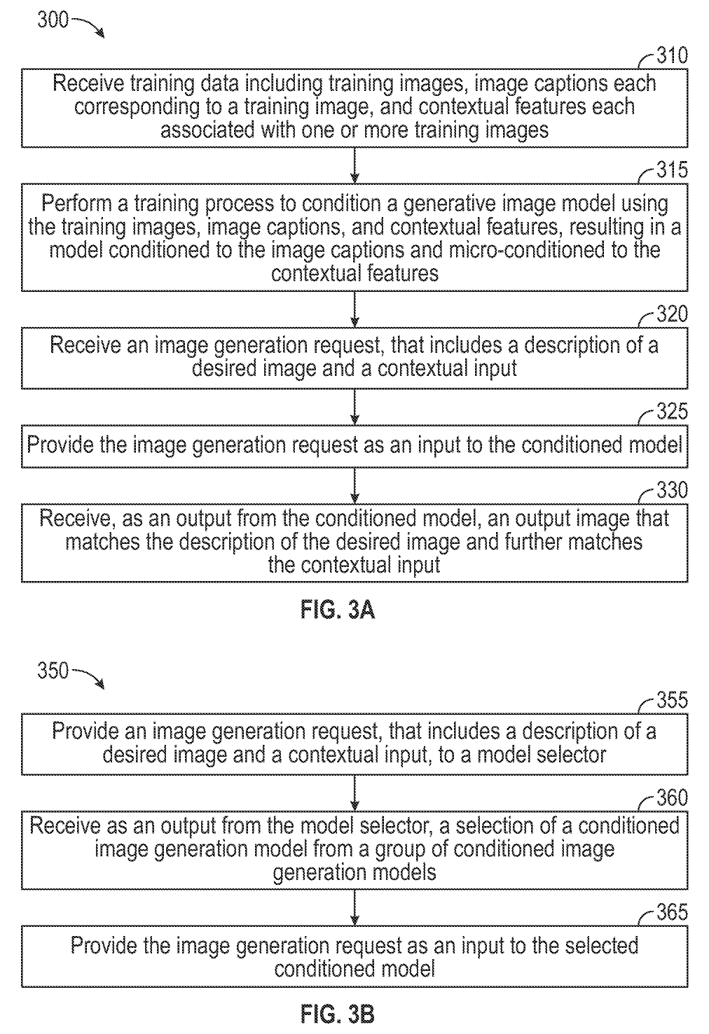

FIG. 3A is a flowchart illustrating a process 300 for conditioned image generation performed by a client device (e.g., client device 110-1, etc.) and/or a client server (e.g., server 130-1, etc.), according to some embodiments. In some embodiments, one or more operations in process 300 may be performed by a processor circuit (e.g., processors 205, etc.) executing instructions stored in a memory circuit (e.g., memories 220, etc.) of a client device (e.g., client device 110-1) and/or a server (e.g., server 130-1) of a system for image generation (e.g., system 200, etc.) as disclosed herein. For example, various operations in process 300 may be performed by image generation application 222, image generation engine 242, training module 252, or some combination thereof. Moreover, in some embodiments, a process consistent with this disclosure may include at least operations in process 300 performed in a different order, simultaneously, quasi-simultaneously, or overlapping in time.

At 310, the process 300 receives training data. In some embodiments, the training data includes training images, image captions corresponding to each of the training images, and contextual features, each associated with one or more of the training images.

The contextual features may include, but are not limited to, location data, moderation labels, historical labels, annotations, and/or user profile data. The user profile data may be data from user accounts on a social network, for example.

At 315, the process 300 performs a training process to condition a generative image model using the training images, the image captions, and contextual features, resulting in a conditioned model that is capable of generating images conditioned to both the image captions and the contextual features. The conditioned model may equivalently be referred to as being conditioned to the image captions and micro-conditioned to the contextual features.

In some embodiments, the training process may be executed by a training module (e.g., training module 252). The image captions may be encoded by a text encoder, and/or the contextual features may be encoded by a context encoder, for use in the training of the image generation model. In some embodiments, the training module may include one or both of the text encoder and the context encoder.

In some embodiments, the contribution of a particular training image to an optimization loss of the training process is based on an image caption corresponding to the particular training image, and a contextual feature corresponding to the particular training image. More than one training image may be associated with the contextual feature, and likewise, any given training image may be associated with more than one contextual feature.

In some embodiments, each training image stores its corresponding image caption and/or corresponding contextual feature(s) as metadata tags.

In some embodiments, the generative image model may be any type of generative image model, including but not limited to a Generative Adversarial Network (GAN), a Variational Autoencoder (VAE), an autoregressive model, a diffusion model, or a transformer-based architecture. The generative image model may take as an input a text prompt, an image prompt, a voice prompt, or any other type of prompt, and based on the prompt, return a generated image. The generated image may be any type of visual image, including but not limited to photo-realistic images, illustrations, cartoons, animation, video, and the like.

At 320, the process 300 receives an image generation request, that includes a description of a desired image (equivalently referred to as a “prompt”) and at least one contextual input. More than one contextual input may be provided in addition to the prompt.

In some embodiments, the image generation request is received from a user account, and the image content is personalized to the user account based on the contextual input. As an example, the user account may be for a social media network, and the contextual input may include data from a user profile associated with the user account.

In some embodiments, the contextual input may include, but is not limited to, a location, a moderation label, a historical label, an output image property, and an output image type. Image types may include, but are not limited to, photo-realistic images, illustrations, cartoons, animation, video, and the like.

At 325, the process 300 provides the image generation request as an input to the conditioned model. The prompt and the contextual input(s) may be provided as inputs to the conditioned model.

At 330, the process 300 receives as an output from the conditioned model, in response to the image generation request, an output image that includes image content that matches at least part of the description of the desired image and further matches the contextual input(s). As an example, if the contextual input includes data associated with a user account, then the image content may be personalized to the user account.

In some embodiments, one or more operations of process 300 (e.g., operation 310 and 315) may be used to train multiple generative image models, resulting in multiple conditioned models. These models may be trained on different sets of training data, including but not limited to different sets of training images, respective captions, and/or associated contextual features. During training, multiple specialized models might be trained with different datasets for different purposes. Each one of those models might be conditioned to different context features for personalization and/or customization of generated image output.

In some embodiments, some image generation models have higher fidelity than others. The specificity of the selected model is dependent on the goal and intent of the image generation request, which can be discerned in some embodiments by analysis of the prompt and the contextual inputs that comprise the image generation request.

As an example, for an image generation request that pertains to the historical past, a model may be selected that provides results that are consistent with the historical facts. An image generation request that specifies “generate an image of a president of the United States from the 1800s” would preferably not return an image of a contemporary president, or a president who is African-American, since this would not be consistent with the historical record. However, an image generation request about a future president or a fictional president would not be historically constrained by race or ethnicity in the resulting image.

Some embodiments use a model selector to select an appropriate conditioned model from the multiple generative image models, based on the image generation request (e.g., based on the prompt and/or the contextual inputs), and provide the image generation request to the selected model.

FIG. 3B is a flowchart illustrating a process 350 for image generation model selection performed by a client device (e.g., client device 110-1, etc.) and/or a client server (e.g., server 130-1, etc.), according to some embodiments. In some embodiments, one or more operations in process 350 may be performed by a processor circuit (e.g., processors 205, etc.) executing instructions stored in a memory circuit (e.g., memories 220, etc.) of a client device (e.g., client device 110-1) and/or a server (e.g., server 130-1) of a system for image generation (e.g., system 200, etc.) as disclosed herein. For example, various operations in process 350 may be performed by image generation application 222, image generation engine 242, training module 252, or some combination thereof. Moreover, in some embodiments, a process consistent with this disclosure may include at least operations in process 350 performed in a different order, simultaneously, quasi-simultaneously, or overlapping in time. In some embodiments, some or all of the operations of process 350 may be performed as part of operation 325 of process 300.

At 355, the process 350 provides an image generation request, including a description of the desired image and one or more contextual inputs, to a model selector. In some embodiments, the model selector may be a machine learning-based selector or an artificial intelligence-based selector, including but not limited to a natural language understanding model, a neural network, a large language model, and the like.

At 360, the process 350 receives as an output from the model selector, a selection of a conditioned image generation model from a group of conditioned image generation models. In making the selection, the model selector may take into account the content of the description of the desired image, for example to ascertain the intent of the image generation request. The model selector may also take into account the content of the contextual input(s), for example to determine what type of model(s) may be conditioned to those inputs. The entire content of the image generation request may be used by the model selector to determine the optimal selection of the image generative model.

At 365, the process 350 provides the image generation request as an input to the selected conditioned model, resulting in an output generated image. In some embodiments, the model selector directly provides the prompt input and the contextual input(s) to the selected conditioned model.

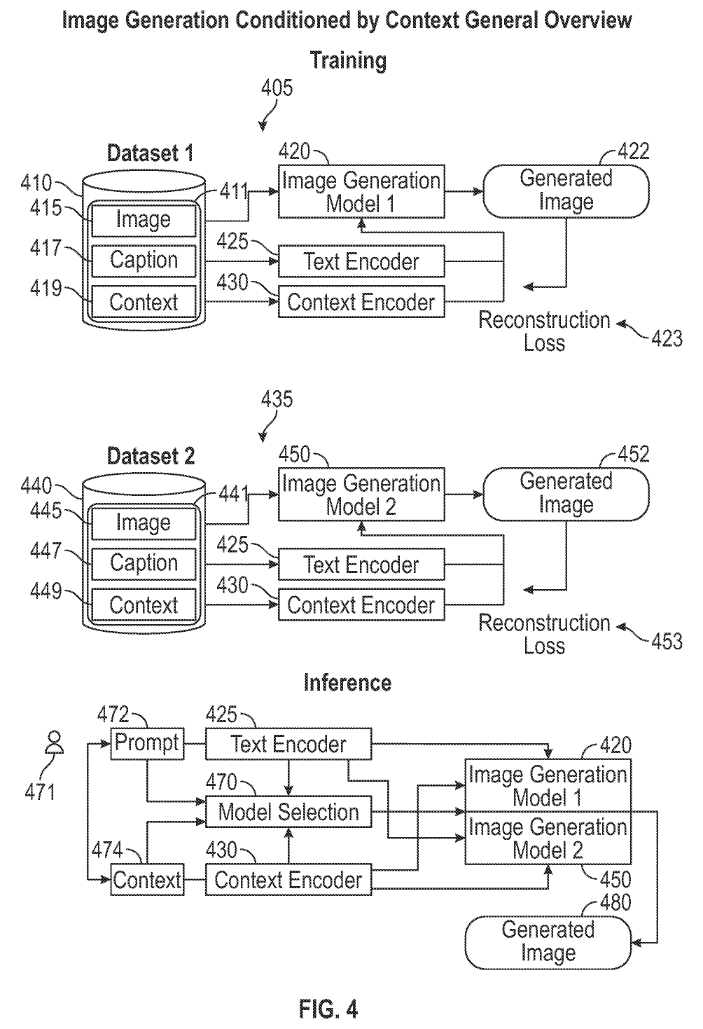

FIG. 4 is a block diagram that illustrates training and inference using multiple image generation models, according to some embodiments. In the example of FIG. 4, a training pipeline 405 is shown that uses a training data set 410 having multiple training images, of which an exemplary training image 411 is shown in more detail. The training image 411 includes image data 415, an associated image caption 417, and one or more contextual features 419. The image caption 417 and/or the contextual features 419 may be stored as metadata tags (e.g., as entries within a header structure) of the image data 415, stored alongside the image data 415 in a same storage, or retrieved from an external database (e.g., database 152, according to some embodiments).

In the example of FIG. 4, the training data set 410 may be used to train an image generation model 420. Using the training data set 410 as an input, the image generation model 420 outputs one or more generated images 422, which are then compared to the ground truth images (e.g., image data 415) using a loss function (not shown). A reconstruction loss 423 is computed using the loss function and used to optimize the variables of the image generation model 420.

The reconstruction loss 423 (also referred to as an optimization loss) may be calculated by various methods corresponding to the image generation model 420, including but not limited to image subtraction in pixel space, a vector difference in a vector representation space, a matrix difference, and the like. The training process optimizes the image generation model 420 to generate target images based on both an image prompt (corresponding to the image captions) and contextual inputs (corresponding to the contextual features).

The conditioning of the image generation model 420 to image captions and micro-conditioning to contextual features may be implemented in a number of different ways. This additional information may need to be encoded and/or embedded so that it can be consumed by the image generation model being trained. In some embodiments, as illustrated with the example of FIG. 4, the image captions may be encoded using a text encoder 425, and the contextual features may be separately encoded by a context encoder 430. As an example, the text encoder 425 may be a large language model. Therefore, the image generation model 420 may receive two separate inputs during training, one for each conditioning type, as shown in FIG. 4. In other embodiments, a single encoder (not shown) may be used to encode the image captions and the contextual features, either separately as different inputs, or by combining the image captions and contextual features as a single input.

In the example of FIG. 4, a second training pipeline 435 is also shown, which is similar to the training pipeline 405 discussed above. In the training pipeline 435, training data set 440 is shown having multiple training images, of which an exemplary training image 441 is shown in more detail. The training image 441 includes image data 445, an associated image caption 447, and one or more contextual features 449. The training data set 440 may be used to train an image generation model 450, which is a different model than image generation model 420. Using the training data set 440 as an input, the image generation model 450 outputs one or more generated images 452, which are then compared to the ground truth images (e.g., image data 445) using a loss function (not shown). A reconstruction loss 453 is computed using the loss function and used to optimize the variables of the image generation model 450. During training, the image captions may be encoded using the text encoder 425, and the contextual features may be separately encoded by the context encoder 430. In the example of FIG. 4, the same text encoder 425 and context encoder 430 is used for training of both models. In some embodiments, different encoders for text and context may be used for training different models.

In the example of FIG. 4, a model selector 470 is shown, that selects (during an inference phase) between trained (conditioned) image generation models, e.g., trained image generation model 420 and image generation model 450. The model selector 470 receives (e.g., from a user account 471) a prompt input 472 and at least one contextual input 474 and uses these inputs to select between image generation models.

In the example of FIG. 4, the prompt input 472 is encoded by the text encoder 425 before being processed by the model selector 470, and the contextual input 474 is encoded by the context encoder 430 before being processed by the model selector 470. Alternatively, the prompt input 472 and/or the contextual input 474 may be directly provided to the model selector 470. The model selector 470 may itself include a text encoder and/or a context encoder.

The group of conditioned image generation models may have different types, including but not limited to photo generation models, illustration generation models, video generation models, and the like. Even though only two models are shown in FIG. 4, any number of models may be trained and subsequently selected from by the model selector 470.

After selecting an image generation model, the prompt input 472 and the contextual input 474 are provided to the selected image generation model, resulting in an output generated image 480. The model selector 470 may provide these inputs to the selected model directly, in some embodiments.

### Training Phase Examples

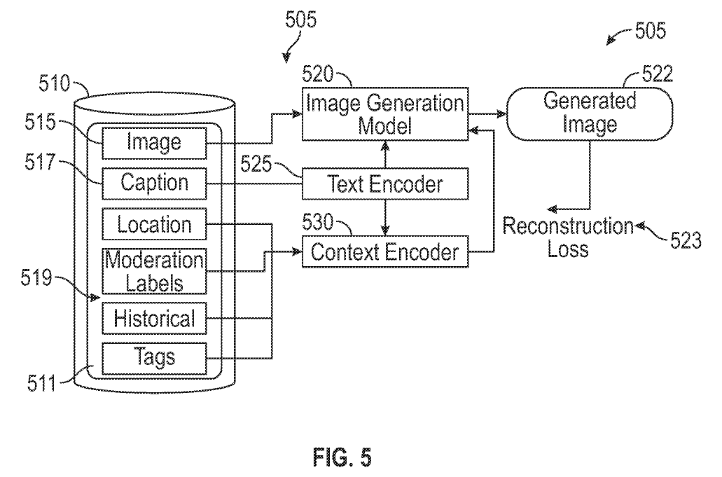

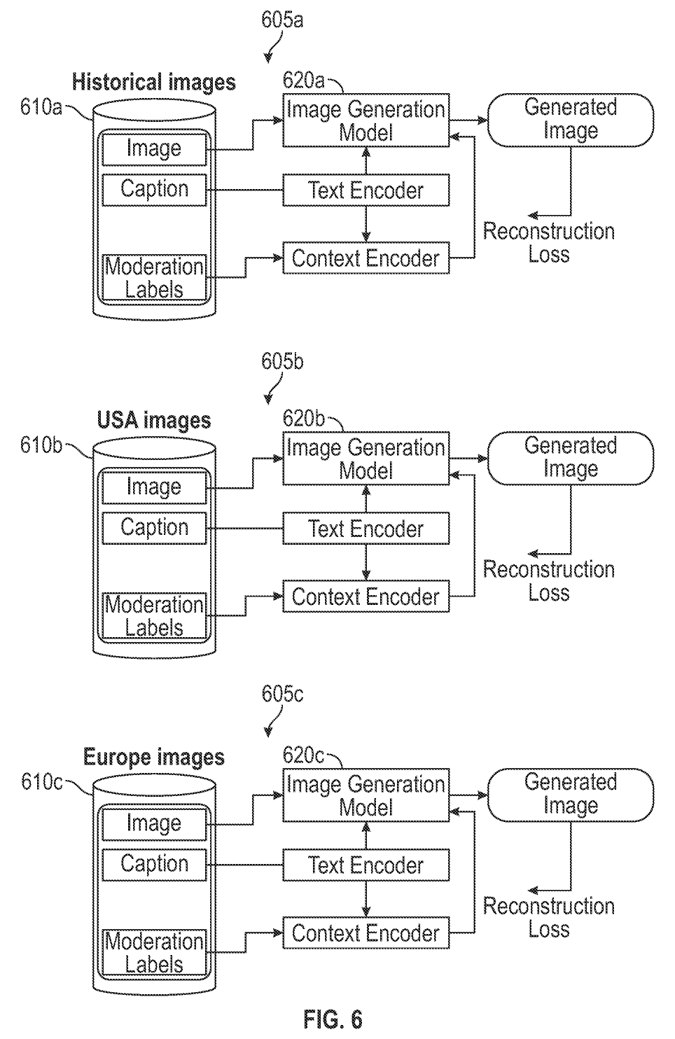

Specific examples of personalized image generation according to various training embodiments are now provided. These examples are provided in FIGS. 5 and 6 below.

FIG. 5 is a block diagram that illustrates micro-conditioning an image generation model to multiple contextual features, according to some embodiments. The training embodiments shown in FIG. 5 are similar to the training embodiments discussed above with respect to FIG. 4, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Specifically, FIG. 5 shows a training pipeline 505, in which training data set 510 is shown having multiple training images, of which an exemplary training image 511 is shown in more detail. The training image 511 includes image data 515, an associated image caption 517, and one or more contextual features 519. The training data set 510 may be used to train an image generation model 520. Using the training data set 510 as an input, the image generation model 520 outputs one or more generated images 522, which are then compared to the ground truth images (e.g., image data 415) using a loss function (not shown). A reconstruction loss 523 is computed using the loss function and used to optimize the variables of the image generation model 520. During training, the image captions may be encoded using a text encoder 525, and the contextual features 519 may be separately encoded by the context encoder 530.

In the example of FIG. 5, the image generation model 520 is a text-to-image model that is trained to generate images given a conditioning text and conditioned on additional information (e.g., the contextual features 519). The model is optimized to learn to generate an image aligned with a given input text, but also with additional given input context from the conditioning information. In this example, the conditioning information includes the image location (i.e., country), image moderation labels (i.e., adult, violent, drugs, safe, kids friendly, etc.), a flag indicating that the image depicts historical content, and metadata tags. The metadata tags may be manually applied to the image data 515, or automatically applied using a classifier or other automated tool. The conditioning information may be previously annotated, extracted from the image, extracted from the image caption, or come from a different source. The conditioning information may also be extracted from the image or the caption (i.e., a classifier inferring if the image/caption depicts adult content) either offline or online.

As an example, if the caption is “a city” and the location is “Spain,” the image generation model 520 will learn to generate a Spanish city. If the caption is “a WWII scene” and context indicates “historical image” and “kids friendly,” the image generation model 520 will learn to generate an image accordingly (for example, a scene that is historically accurate for WWII, but which does not have explicit violence).

In some embodiments, each caption 517 may be encoded by a text encoder (e.g., text encoder 525) and some or all of the contextual features 519 may be encoded by a dedicated encoder (e.g., context encoder 530). Some or all of the features may be encoded by the same context encoder (as depicted in the example of FIG. 5) or by different encoders. For example, some context conditioning features may also be text and encoded with the text encoder 525 in the same manner as the caption 517.

In some embodiments, the image generation model 520 may have different architectures: Diffusion model, autoregressive model, GAN, etc. The image generation model 520 may be optimized with a reconstruction loss, with a different loss (i.e., adversarial loss), or with a combination of objectives.

In the example of FIG. 5, the image generation model 520 is conditioned to text, and additionally to explicit context information. In some embodiments, portions of the additional context conditioning may be dropped randomly during training, so that the model still learns how to generate images when none or a few context features are available.

In some embodiments, the image generation model 520 may be a text-to-image model. In other embodiments, the image generation model 520 may be an image generation model conditioned on a different information instead of text, including but not limited to a sketch-to-image model and an audio-to-image-model. In some embodiments, the image generation model 520 may be a model to generate a different modality other than images: i.e., video.

FIG. 6 is a block diagram that illustrates training multiple image generation models, each of them micro-conditioned to different contextual features, according to some embodiments. In some embodiments, each image generation model is the same base model, but micro-conditioned to different contextual inputs and trained with different training data. The training embodiments shown in FIG. 6 are similar to the training embodiments discussed above with respect to FIG. 4 and FIG. 5, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Specifically, FIG. 6 shows training pipelines 605a, 605b, and 605c (collectively referred to hereafter as “training pipelines 605”), in which training data sets 610a, 610b, and 610c (collectively referred to hereafter as “training data sets 610”) have multiple training images, of which respective exemplary training images are shown in more detail. The training images each include image data, associated image captions, and contextual features (in this example, moderation labels). The training data sets 610 may be used to train respective image generation models 620a, 620b, and 620c (collectively referred to hereafter as “image generation models 620”). Using the training data sets 610 as inputs, the image generation models 620 each respectively output one or more generated images which are then compared to the ground truth images (e.g., image data) using loss functions (not shown). Reconstruction losses are computed using the respective loss function and used to optimize the variables of the respective image generation models 620. During training, the image captions may be encoded using text encoders, and the contextual features may be separately encoded by context encoders.

In the example of FIG. 6, the image generation models 620 are trained to generate images personalized for a given user, context, or generation model, by training multiple models and then guiding generations to the right model. FIG. 6 depicts different fine-tunings (micro-conditioning) of a single base text-to-image model with different fine-tuning training data sets 610 that are curated to fit a given generation mode.

As an example, one application of conditioning image generation to context is generating different images for users based in the United States (e.g., using image generation model 620b) and in Europe (e.g., using image generation model 620c). One reason to do that may be different aesthetic preferences. Each of these fine-tunings will result in a different model, even though the original base model may have been the same. During inference, user queries may be guided to a given model based on the context features. Even with a light fine-tuning, text-to-image model generations may be heavily shifted, i.e., to match given style preferences.

Fine-tuning datasets may be curated in different manners based on the context features. In the example of FIG. 6, the training data set 610b (“USA Images”) may have images taken in the US by USA-based artists, and the training data set 610c (“Europe Images”) is the same but for Europe and EU-based artists. Multiple models 620 may be trained, at least one for each country or region. A model may also be trained for each moderation category (i.e., kids-safe model), style, or any desired category or moderation flag.

In the example of FIG. 6, the “Historical Images” training data set 610a contains images that depict historical facts. It may be relevant to have a model dedicated to historical images generation, since it is known that certain bias corrections may be sensible to be applied there. By guiding historical image generations to a dedicated model (without debiasing) and applying debiasing to the rest, that risk is avoided. The risk can be similarly mitigated by conditioning a single model to a “historical” flag (as depicted in FIG. 5, described above), and applying the debiasing strategy accordingly (i.e., only to non-historical images during training).

The specialized fine-tuned models 620 may also be conditioned to additional context as described above with reference to FIG. 4 and FIG. 5. In the examples shown in FIG. 5, for example, the models are conditioned to moderation labels.

In some embodiments, the fine-tuning may be applied with different techniques, e.g., using Low-Rank Adaptation of Large Language Models (LORA) for lighter computation and weights, or using a different optimization technique as the one used to train the baseline model.

### Inference Phase Examples

During inference, an image generation model is conditioned to context information as it was during training. Context information during inference can come from the user or session (i.e., user country, user latest activity in the application), might be set explicitly by the user (i.e., “kids’ mode” selection) or might be set in the background by the model provider (for instance, different applications oriented to different regions might offer the same model but condition it to a different country).

In some embodiments, context features may be extracted from the user session, input by the user, set in the background, and/or may be extracted by other machine-learning or artificial intelligence-based models. As an example, an image generation model may extract from the user session activity information or from the input prompt, whether the generated image should be a historical image or not. Alternatively, an image generation model may extract, from user session information, user demographic data and/or preferences data.

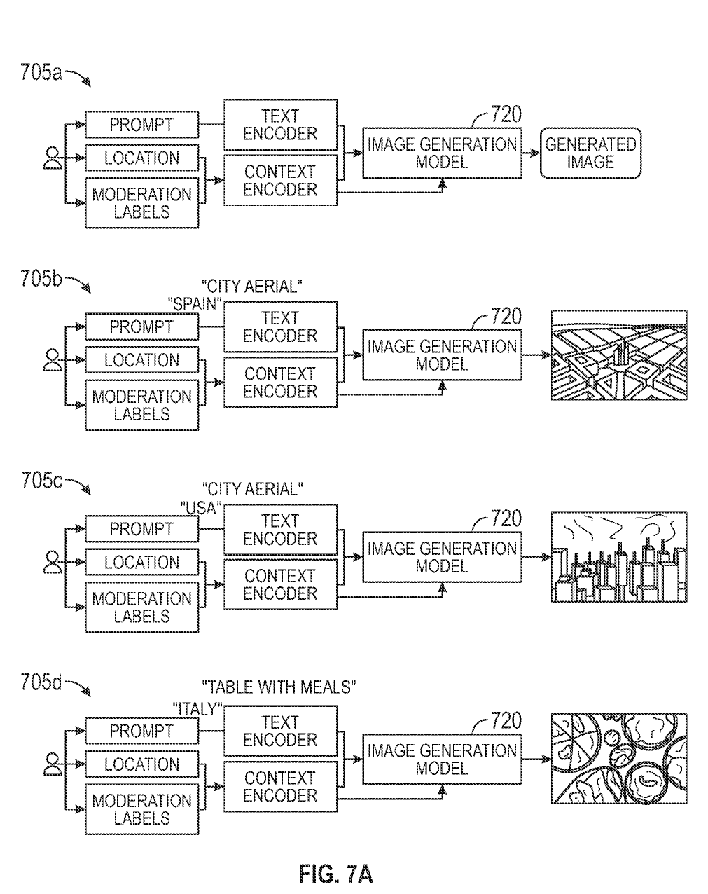

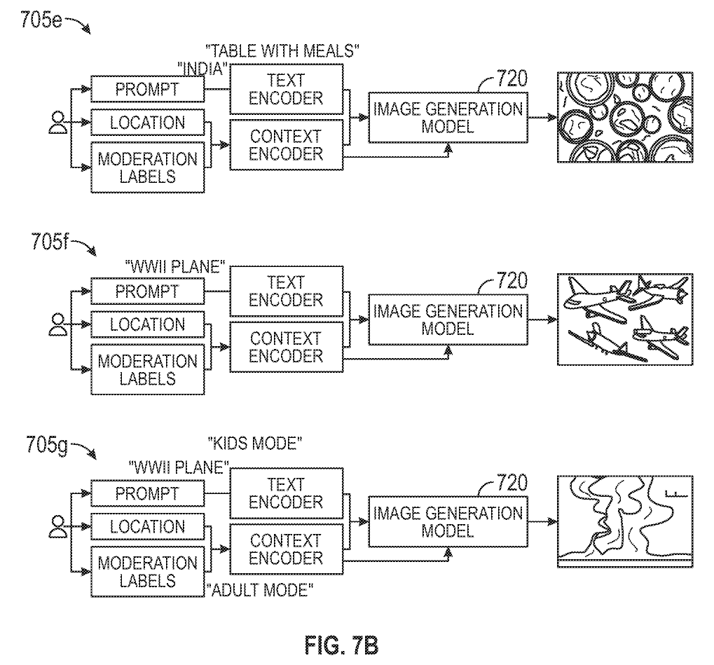

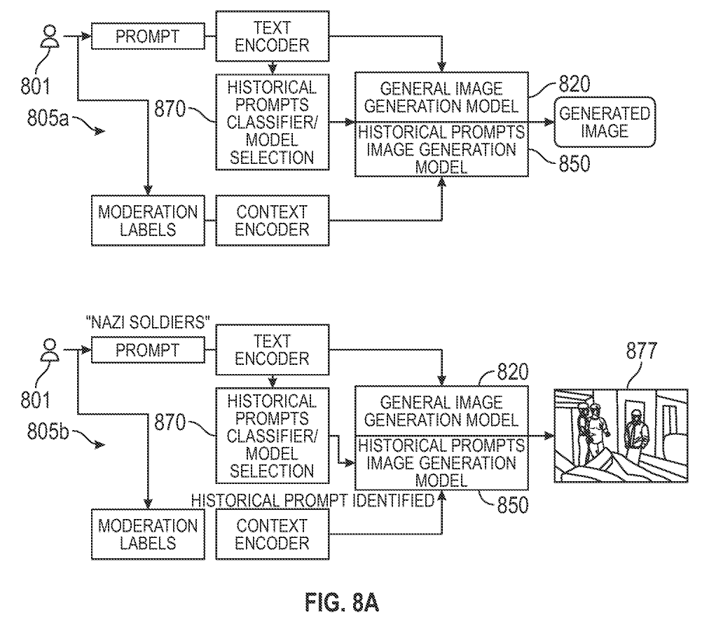

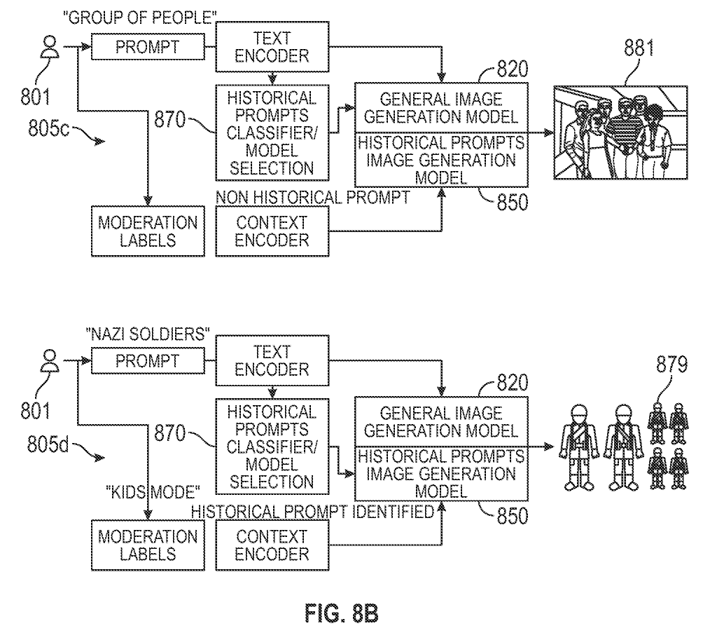

Specific examples of personalized image generation according to various inference embodiments are now provided. These examples are provided in FIGS. 7 and 8 below.

FIG. 7A and FIG. 7B show a block diagram that illustrates inference scenarios 705a-705g where a single image generation model 720 is conditioned to different context features, according to some embodiments. The inference embodiments shown in FIGS. 7A and 7B are similar to the inference embodiments discussed above with respect to FIG. 4, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

Each inference scenario in FIG. 7A and FIG. 7B depicts examples of inference with different context information. Several examples are shown:

When the user asks for a “city aerial” image, the generated image shows Barcelona if the user is in Spain (as in inference scenario 705b) and shows New York if the user is in the USA (as in inference scenario 705c).

When the user prompt is “table with meals,” the generated image is an image of Italian food if the user is in Italy (as in inference scenario 705d), and an image of Indian food if the user is in India (as in inference scenario 705e).

When the user asks for a “WWII plane” image, the generated image is a kids-friendly planes drawing if the kids’ mode is on (as in inference scenario 705f), and a real image if kids’ mode is not on (as in inference scenario 705g).

The example of FIG. 7A and FIG. 7B shows only location and moderation labels context; however, the context features are not limited to only those types of features. In addition, multiple context features may be active at once. Context features may also be deactivated, and let the model only pay attention to the prompt conditioning, as in inference scenario 705a.

FIG. 8A and FIG. 8B show a block diagram that illustrates inference scenarios 805a-805d where model selection is performed based on context features, where the selected image generation models are conditioned to different context features, according to some embodiments. The inference embodiments shown in FIG. 8A and FIG. 8B are similar to the inference embodiments discussed above with respect to FIG. 4, FIG. 7A, and FIG. 7B, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, for each inference request, one of image generation model 820 or image generation model 850 are selected by model selector 870 (equivalently referred to as a “model router”), based on the prompt and contextual inputs (in this case, a moderation label, though different and/or additional contextual inputs could also be provided). In this example, image generation model 820 is a general image generation model, which may be micro-conditioned to one or more contextual features (e.g., image generation model 720, image generation model 620b, image generation model 620c, etc.).

Furthermore, in this example, image generation model 850 is an image generation model that is dedicated to historical image generation, including certain bias corrections to ensure that output does not contradict historical facts. The image generation model 850 may have been trained on historical training data (such as training data set 610a) or micro-conditioned to a “historical” flag (e.g., image generation model 520, image generation model 620a, etc.).

Each inference scenario in FIG. 8 depicts examples of inference with different context information. Several examples are shown:

When a user 801 asks for a “Nazi soldiers” image, the model selector 870 determines that the prompt contains a historical context and routes the image generation request to the historical image generation model 850, as in inference scenarios 805b and 805d.

In inference scenario 805b, the kids’ mode is not activated, resulting in an output image 877 from image generation model 850 that includes depictions of actual Nazi soldiers.

In inference scenario 805d, kids’ mode is activated, resulting in an output image 879 from image generation model 850 that shows cartoon versions of different uniforms worn by such soldiers in that era.

If the user 801 asks for a “group of people” in the prompt, then the model selector 870 determines that this is a non-historical prompt and routes the image generation request to general image generation model 820, resulting in an output image 881 that is not constrained by any historical facts.

The example of FIG. 8A and FIG. 8B shows only moderation labels context; however, the context features are not limited to only those types of features. In addition, multiple context features may be active at once. Context features may also be deactivated, and let the model only pay attention to the prompt conditioning, as in inference scenario 805a.

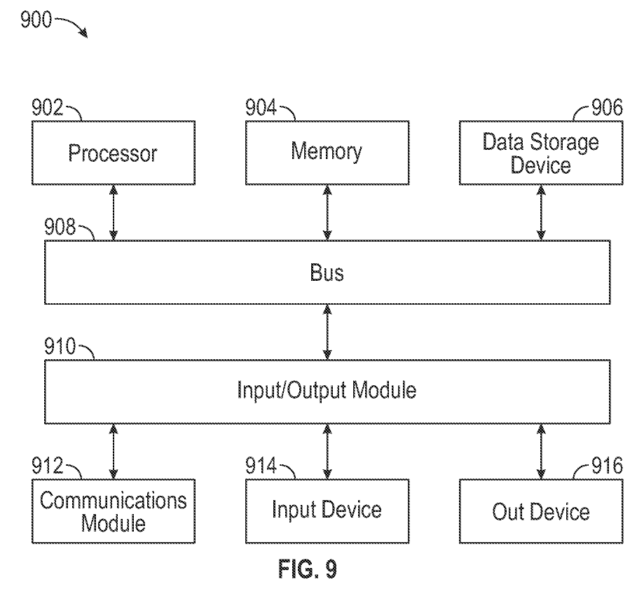

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities. As a non-limiting example, the computer system 900 may be one or more of the servers 130 and/or the client devices 110.

Computer system 900 includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

Some embodiments may be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the computer system 900 reads application data and provides an application, information may be read from the application data and stored in a memory device, such as the memory 904. Additionally, data from the memory 904 servers accessed via a network, the bus 908, or the data storage 906 may be read and loaded into the memory 904. Although data is described as being found in the memory 904, it will be understood that data does not have to be stored in the memory 904 and may be stored in other memory accessible to the processor 902 or distributed among several media, such as the data storage 906.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

### REFERENCES

Zhang, L. (2024). ControlNet: Let us control diffusion models! GitHub. https://github.com/lllyasviel/ControlNet.

Stability AI. (2024). Generative Models. GitHub. https://github.com/Stability-AI/generative-models.

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for image generation, comprising:
receiving a training data comprising a plurality of training images, a plurality of image captions each corresponding to one of the plurality of training images, and a plurality of contextual features each associated with one or more of the plurality of training images; and
performing a training process to condition a generative image model using the plurality of training images, the plurality of image captions, and the plurality of contextual features, resulting in a conditioned model that generates images conditioned to both the plurality of image captions and the plurality of contextual features.

2. The method of claim 1, further comprising:
receiving an image generation request comprising a description of a desired image and further comprising a contextual input;
providing the image generation request to the conditioned model; and
receiving as an output from the conditioned model in response to the image generation request, an output image that comprises image content that matches at least part of the description of the desired image and further matches the contextual input.

3. The method of claim 2, wherein the image generation request is received from a user account, the image content is personalized to the user account based on the contextual input, and the contextual input comprises data from a user profile associated with the user account.

4. The method of claim 3, wherein the contextual input is a first contextual input, the image generation request further comprises a second contextual input, and the image content is further personalized to the user account based on the second contextual input.

5. The method of claim 2, wherein the contextual input is a first contextual input, the image generation request further comprises a second contextual input, and the image content further matches the second contextual input.

6. The method of claim 2, wherein the contextual input comprises one or more of a location, a moderation label, a historical label, an output image property, and an output image type.

7. The method of claim 2, wherein the training data is a first training data, the plurality of training images is a first plurality of training images, the plurality of image captions is a first plurality of image captions, the plurality of contextual features is a first plurality of contextual features, the generative image model is a first generative image model, the output is a first output, and the conditioned model is a first conditioned model, the method further comprising:
receiving a second training data comprising a second plurality of training images, a second plurality of image captions each corresponding to one of the second plurality of training images, and a second plurality of contextual features each associated with one or more of the second plurality of training images;
performing a second training process to condition a second generative image model using the second plurality of training images, the second plurality of image captions, and the second plurality of contextual features, resulting in a second conditioned model that generates images conditioned to both the second plurality of image captions and the second plurality of contextual features;
providing the description of the desired image and the contextual input to a model selector; and
receiving as a second output from the model selector, a selection of the first conditioned model from a plurality of models comprising the first conditioned model and the second conditioned model,
wherein providing the image generation request to the first conditioned model is responsive to receiving the selection of the first conditioned model from the model selector.

8. The method of claim 7, wherein the first conditional model is a first model type from a plurality of image generation model types, and the second conditional model is a second model type from the plurality of image generation model types, and the plurality of image generation model types comprise a photo generation model, an illustration generation model, a video generation model.

9. The method of claim 1, wherein the contextual features comprise one or more of location data, moderation labels, historical labels, annotations, or user profile data.

10. The method of claim 1, wherein a contribution of each training image in the plurality of training images to an optimization loss of the training process is based on a corresponding image caption and a corresponding contextual feature.

11. The method of claim 1, wherein each training image in the plurality of training images comprises a corresponding image caption stored as a metadata tag.

12. The method of claim 1, wherein each training image in the plurality of training images comprises a corresponding contextual feature stored as a metadata tag.

13. The method of claim 1, wherein the generative image model is one of a Generative Adversarial Network (GAN), a Variational Autoencoder (VAE), an autoregressive model, a diffusion model, and a transformer-based architecture.

14. A non-transitory computer-readable medium storing a program for image generation, which when executed by a computer, configures the computer to:
receive a training data comprising a plurality of training images, a plurality of image captions each corresponding to one of the plurality of training images, and a plurality of contextual features each associated with one or more of the plurality of training images; and
perform a training process to condition a generative image model using the plurality of training images, the plurality of image captions, and the plurality of contextual features, resulting in a conditioned model that generates images conditioned to both the plurality of image captions and the plurality of contextual features.

15. The non-transitory computer-readable medium of claim 14, wherein the program, when executed by the computer, further configures the computer to:
receive an image generation request comprising a description of a desired image and further comprising a contextual input;
provide the image generation request to the conditioned model; and
receive as an output from the conditioned model in response to the image generation request, an output image that comprises image content that matches at least part of the description of the desired image and further matches the contextual input.

16. The non-transitory computer-readable medium of claim 15, wherein the training data is a first training data, the plurality of training images is a first plurality of training images, the plurality of image captions is a first plurality of image captions, the plurality of contextual features is a first plurality of contextual features, the generative image model is a first generative image model, the output is a first output, and the conditioned model is a first conditioned model, and wherein the program, when executed by the computer, further configures the computer to:
receive a second training data comprising a second plurality of training images, a second plurality of image captions each corresponding to one of the second plurality of training images, and a second plurality of contextual features each associated with one or more of the second plurality of training images;
perform a second training process to condition a second generative image model using the second plurality of training images, the second plurality of image captions, and the second plurality of contextual features, resulting in a second conditioned model that generates images conditioned to both the second plurality of image captions and the second plurality of contextual features;
provide the description of the desired image and the contextual input to a model selector; and
receive as a second output from the model selector, a selection of the first conditioned model from a plurality of models comprising the first conditioned model and the second conditioned model,
wherein providing the image generation request to the first conditioned model is responsive to receiving the selection of the first conditioned model from the model selector.

17. The non-transitory computer-readable medium of claim 15, wherein the contextual input is a first contextual input, the image generation request further comprises a second contextual input, and the image content further matches the second contextual input.

18. A system for image generation, comprising:
a processor; and
a non-transitory computer readable medium storing a set of instructions, which when executed by the processor, configure the system to:
receive a training data comprising a plurality of training images, a plurality of image captions each corresponding to one of the plurality of training images, and a plurality of contextual features each associated with one or more of the plurality of training images; and
perform a training process to condition a generative image model using the plurality of training images, the plurality of image captions, and the plurality of contextual features, resulting in a conditioned model that generates images conditioned to both the plurality of image captions and the plurality of contextual features.

19. The system of claim 18, wherein the instructions, when executed by the processor, further configure the system to:
receive an image generation request comprising a description of a desired image and further comprising a contextual input;
provide the image generation request to the conditioned model; and
receive as an output from the conditioned model in response to the image generation request, an output image that comprises image content that matches at least part of the description of the desired image and further matches the contextual input.

20. The system of claim 19, wherein the training data is a first training data, the plurality of training images is a first plurality of training images, the plurality of image captions is a first plurality of image captions, the plurality of contextual features is a first plurality of contextual features, the generative image model is a first generative image model, the output is a first output, and the conditioned model is a first conditioned model, and wherein the instructions, when executed by the processor, further configure the system to:
receive a second training data comprising a second plurality of training images, a second plurality of image captions each corresponding to one of the second plurality of training images, and a second plurality of contextual features each associated with one or more of the second plurality of training images;
perform a second training process to condition a second generative image model using the second plurality of training images, the second plurality of image captions, and the second plurality of contextual features, resulting in a second conditioned model that generates images conditioned to both the second plurality of image captions and the second plurality of contextual features;
provide the description of the desired image and the contextual input to a model selector; and
receive as a second output from the model selector, a selection of the first conditioned model from a plurality of models comprising the first conditioned model and the second conditioned model,
wherein providing the image generation request to the first conditioned model is responsive to receiving the selection of the first conditioned model from the model selector.
